(19) United States
(12) Patent Application Publication
(10) Pub. No.: US 2018/0046136 A1
(43) Pub. Date: Feb. 15, 2018

(54) IMAGE FORMING APPARATUS, CARTRIDGE, AND FRAME BODY USED FOR THE CARTRIDGE

(71) Applicant: CANON KABUSHIKI KAISHA, Tokyo (JP)

(72) Inventors: Akira Suzuki, Naka-gun (JP); Hiroomi Matsuzaki, Mishima-shi (JP); Kazunori Suzuki, Niiza-shi (JP); Toshiteru Yamasaki, Yokohama-shi (JP); Shigeo Miyabe, Yokohama-shi (JP); Takahito Ueno, Mishima-shi (JP); Shogo Satomura, Kawasaki-shi (JP); Masatomi Yoshida, Kawasaki-shi (JP); Nobuharu Hoshi, Yokohama-shi (JP)

(21) Appl. No.: 15/319,057

(22) PCT Filed: Jun. 12, 2015
(86) PCT No.: PCT/JP2015/002952

§ 371 Date: Dec. 15, 2016

(30) Foreign Application Priority Data
Jun. 17, 2014 (JP) 2014-124748
May 8, 2015 (JP) 2015-095772

(51) Int. Cl. G03G 21/18; G03G 15/08; G03G 21/00

(52) U.S. Cl. CPC G03G 21/1814; G03G 21/0029; G03G 15/0812; G03G 2221/1606; G03G 2221/18

(57) ABSTRACT

To provide a structure that includes a small number of components, that is unlikely to be affected by heat, and that allows a blade secured to a frame body and a rotating member to be in contact with each other at a uniform pressure in a longitudinal direction.

A structure includes a rotatable rotating member, a blade, a support member, and a frame body. The blade extends in an axial direction of the rotating member and is in contact with or disposed close to a surface of the rotating member. The support member supports the blade such that one end side of the blade projects toward the rotating member in a lateral direction that intersects the axial direction. The frame body is formed by insert molding in which resin is injected while the support member is secured to a mold. The frame body clamps part of the support member so as to support the support member.

### TECHNICAL FIELD

The present invention relates to an image forming apparatus, a cartridge that is attachable to and detachable from a main body of the image forming apparatus, and a frame body used for the cartridge of the image forming apparatus.

### BACKGROUND ART

The present invention relates to an electrophotographic image forming apparatus and a process cartridge (referred to as “cartridge” hereafter) that is attachable to and detachable from the electrophotographic image forming apparatus. Here, the electrophotographic image forming apparatus (referred to as “image forming apparatus” hereafter) forms an image on a recording material (recording medium) by using an electrophotographic image forming process. Examples of the image forming apparatus include a printer (such as a laser beam printer or an LED printer), a copier, a facsimile machine, a word processor, a multi-function device (multi-function printer) that has the functions of these devices, and so forth.

A process cartridge method that allows the cartridge to be attached to and detached from an apparatus main body of the image forming apparatus is adopted for a related-art image forming apparatus that uses the photoelectric image forming process. With this process cartridge method, electrophotographic photosensitive drum (referred to as “photosensitive drum” hereafter) and process devices that perform operation on the photosensitive drum are integrated with one another in a cartridge, so that maintenance of the image forming apparatus can be simplified.

In such a cartridge, the difference in thermal expansion occurs between a developing blade support plate and a developing frame due to, for example, changes in ambient temperature. This difference causes a problem in that the developing blade is bent. Thus, the difference in contact pressure at which the developing blade is in contact with a developing roller occurs between a central portion and end portions in the longitudinal direction. This may cause density unevenness in an image. In order to address this, a structure has been proposed in which a developing blade is secured to a developing frame by a stepped screw using a wave washer (PTL 1).

### CITATION LIST

### Patent Literature

PTL 1: Japanese Patent Laid-Open No. 11-282251

### SUMMARY OF INVENTION

### Technical Problem

The present invention further develops the above-described related-art structure. With the above-described structure, the developing blade is secured to the developing frame by using the wave washer and the stepped screw. Thus, the number of components is increased and a production process becomes complex.

Furthermore, in the case where the blade and the roller are disposed with a gap therebetween, there may be the difference in thermal expansion between the blade support plate and the frame due to, for example, changes in ambient temperature. This may cause bending of the blade, and accordingly, change the size of the gap.

Accordingly, the present invention provides a structure that allows a blade to be easily secured to a frame body with a small number of components and that can suppress bending of the blade and the frame body caused by, for example, changes in ambient temperature. Thus, in the case where the blade and a rotating member are in contact with each other, the occurrence of the difference in a pressure contact at which the blade and the rotating member are in contact with each other in the axial direction of the rotating member is suppressed. In the case where the developing blade and the rotating member are disposed close to each other with a gap therebetween, changes in the size of the gap are reduced.

### Solution to Problem

A cartridge according to the present invention includes a rotatable rotating member, a blade, a support member, and a frame body. The blade extends in an axial direction of the rotating member and is in contact with or disposed close to a surface of the rotating member. The support member supports the blade such that one end side of the blade projects toward the rotating member in a lateral direction that intersects the axial direction. The frame body is formed by insert molding in which resin is injected while the support member is secured to a mold. The frame body clamps part of the support member so as to support the support member.

A frame body according to the present invention is a frame body for a cartridge that is attachable to and detachable from an image forming apparatus. The frame body is formed by insert molding in which resin is injected while a reinforcing member is secured to a mold. Part of at least one surface of the reinforcing member is exposed.

### Advantageous Effects of Invention

According to the present invention, a structure that allows a blade to be easily secured to a frame body with a small number of components and that suppresses bending of the blade and the frame body caused by, for example, changes in ambient temperature can be provided.

### BRIEF DESCRIPTION OF DRAWINGS

FIG. 1 is a perspective view of a cartridge according to a first embodiment.

FIG. 2 is a sectional view of an image forming apparatus according to the first embodiment.

FIG. 3 is a sectional view of the cartridge according to the first embodiment.

FIG. 4 is a plan view of the cartridge according to the first embodiment.

FIG. 5A illustrates a method of producing the cartridge according to the first embodiment.

FIG. 5B illustrates the method of producing the cartridge according to the first embodiment.

FIG. 6 is a plan view of a cartridge according to a second embodiment.

FIG. 7 is a perspective view of a cartridge according to a third embodiment.

FIG. 8 is a plan view of a cartridge according to a variant.

FIG. 9 is a plan view of a cartridge according to a fifth embodiment.

FIG. 10A is a sectional view of the cartridge according to the fifth embodiment.

FIG. 10B is a sectional view of the cartridge according to the fifth embodiment.

FIG. 11 illustrates a method of producing the cartridge according to the fifth embodiment.

FIG. 12 is a plan view of a cartridge according to a sixth embodiment.

FIG. 13 is a plan view of another structure of the cartridge according to the sixth embodiment.

FIG. 14 is a plan view of another structure of the cartridge according to the sixth embodiment.

### DESCRIPTION OF EMBODIMENTS

Next, further details of embodiments of the present invention will be described with reference to the drawings. In the following description, a longitudinal direction N refers to axial directions of a developer bearing member, that is, a developing roller, and an image bearing body, that is, a photosensitive drum.

### First Embodiment

An Outline of an Entire Structure of an Image Forming Apparatus

The Entire Structure of the Image Forming Apparatus

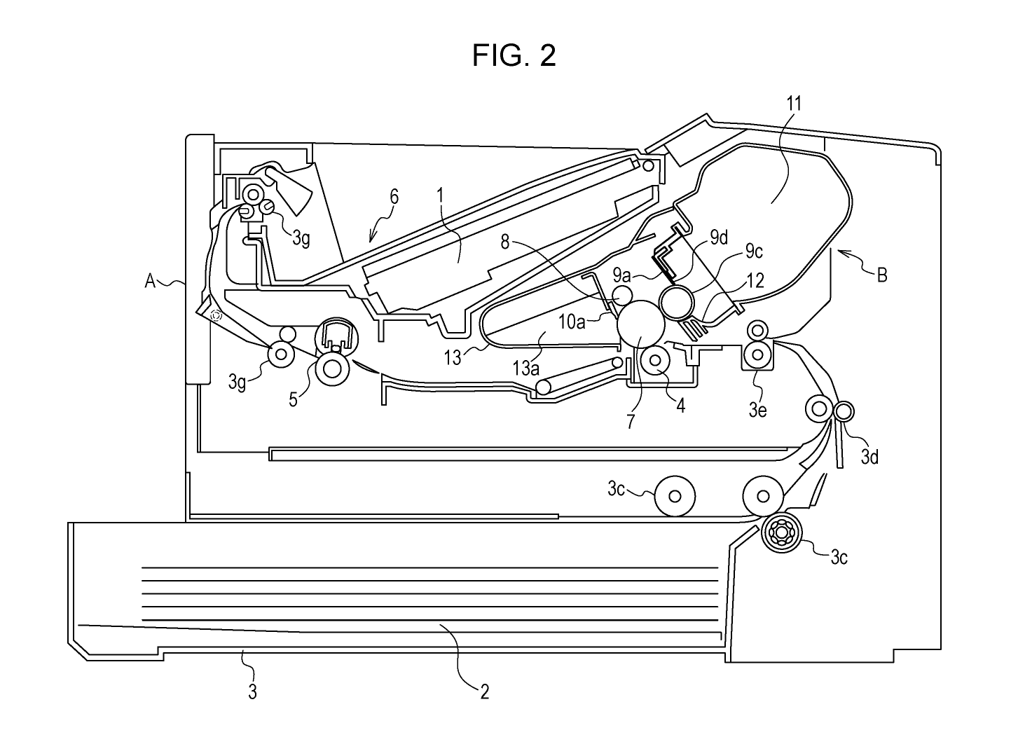

Initially, an outline of the entirety a main body A of an image forming apparatus (referred to as a “main body” hereafter) is described with reference to FIG. 2. As illustrated in FIG. 2, a process cartridge B that is attachable to and detachable from the main body is attached to the main body A. Here, the process cartridge refers to a cartridge into which a photosensitive drum and at least a developing device serving as a process device that performs operation on the photosensitive drum are integrated and which is attachable to and detachable from the main body A of the image forming apparatus.

A rotatable photosensitive drum 7 and process devices disposed around the photosensitive drum 7 are integrally provided in the cartridge B. The process devices around the photosensitive drum 7 include, for example, a charging roller 8, a developing roller 9c, a developing blade 9d, and a cleaning blade 10a. The charging roller 8 uniformly charges a surface of the photosensitive drum 7. The developing blade 9d maintains the thickness of toner attracted to the developing roller 9c at a fixed thickness. The developing roller 9c develops a latent image formed on the photosensitive drum 7 with the toner so as to visualize the latent image. The cleaning blade 10a removes the toner remaining on the photosensitive drum 7 after a toner image formed on the photosensitive drum 7 has been transferred to a recording medium. Furthermore, a light exposure device 1 is disposed above the cartridge B. The photosensitive drum 7 is selectively exposed to light by using the light exposure device 1 in accordance with image information, so that the latent image is formed on the photosensitive drum 7.

A cassette 3 is attached in a lower portion of the main body A. The cassette 3 contains a recording medium 2 or recording media 2. The recording medium 2 or each of the recording media 2 is a sheet of, for example, paper. A recording medium conveying device is provided so that the recording media 2 is conveyed to an upper portion of the main body A through a transfer roller 4 and a fixing device 5. More specifically, a feed roller 3c, a conveying roller pair 3d, and a registration roller pair 3e are provided. The feed roller 3c separates one sheet after another from the recording media 2 in the cassette 3 and feeds each sheet. The conveying roller pair 3d conveys each of the recording media 2 having been fed thereto. The registration roller pair 3e synchronizes the latent image formed on the photosensitive drum 7 with the recording medium 2. Furthermore, the fixing device 5 that fixes the image formed on the recording medium 2 is provided.

When forming an image, the photosensitive drum 7 is rotated and uniformly charged by the charging roller 8. The uniformly charged photosensitive drum 7 is selectively exposed to light from the light exposure device 1. Thus, an electrostatic latent image is formed on the photosensitive drum 7. The latent image is developed by the developing roller 9c. Thus, a toner image is formed on the photosensitive drum 7. The registration roller pair 3e conveys the recording medium 2 to a nip between the photosensitive drum 7 and the transfer roller 4 such that the conveyance of the recording medium 2 is synchronized with this image formation. A voltage is applied to the transfer roller 4, thereby transferring the toner image onto the recording medium 2. Thus, an image is formed on the recording medium 2. The recording medium 2 on which the image has been formed is subjected to heat and pressure by the fixing device 5, so that the toner image is fixed. After that, the recording medium 2 is output to an output unit 6 by an output roller 3g.

### Outline of the Entirety of the Cartridge

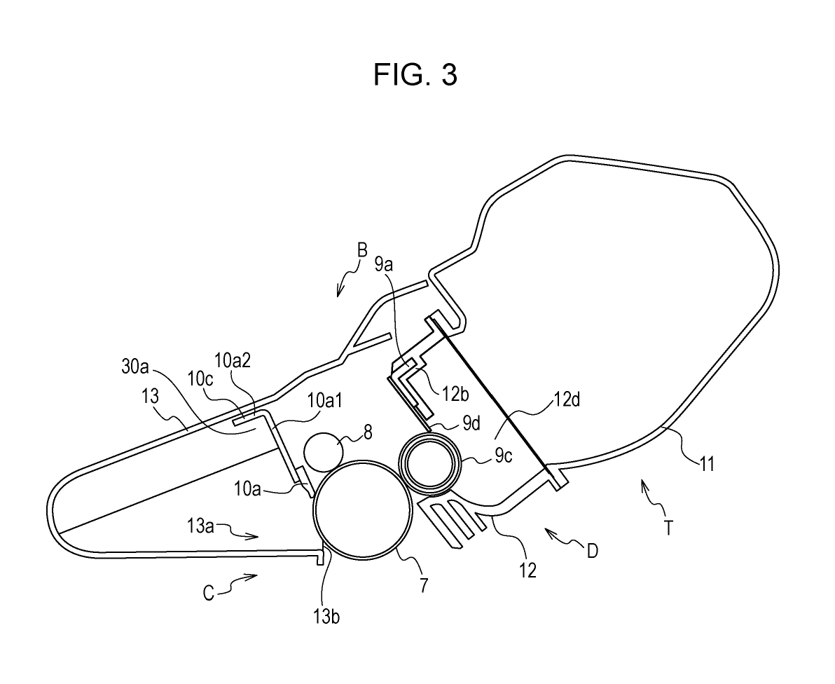

Next, the outline of the entirety of the cartridge B is described with reference to FIG. 3. FIG. 3 is a sectional view of the cartridge B that contains the toner.

The cartridge B includes a cleaning unit C and a developer unit T. The cleaning unit C includes the photosensitive drum 7, the charging roller 8, the cleaning blade 10a, an anti-leakage sheet 13b, and a cleaning container 13 that forms a waste toner chamber 13a. The charging roller 8, the cleaning blade 10a, and the anti-leakage sheet 13b are disposed at a circumference of the photosensitive drum 7, which is a rotating member. The cleaning blade 10a is formed of an elastic member such as rubber and secured to the cleaning container 13 with a second support member 10c, which is supported at a first securing portion 30a, interposed between the cleaning blade 10a and the cleaning container 13. The cleaning blade 10a is in contact with the surface of the photosensitive drum 7 while the cleaning blade 10a is inclined in a rotational direction of the photosensitive drum 7 relative to a normal to the photosensitive drum 7. This cleaning blade 10a causes residual toner removed from the surface of the photosensitive drum 7 to drop into the waste toner chamber 13a. Furthermore, in order to prevent leakage of the waste toner from the waste toner chamber 13a, the anti-leakage sheet 13b is in contact with the photosensitive drum 7. The photosensitive drum 7 is rotated in accordance with image forming operation by transmitting a drive force from the main body A to the cleaning unit C. The charging roller 8 is rotatably attached to the cleaning unit C and pressed against the photosensitive drum 7, thereby being rotated by the photosensitive drum 7.

The developer unit T includes a developing unit D and a toner container 11. The toner container 11 contains the toner to be supplied to an opening 12d of a developing container 12 of the developing unit D. The developing unit D includes the developing roller 9c, the developing blade 9d, an anti-blowoff sheet 14, and the developing container 12. The developing roller 9c is in contact with the photosensitive drum 7, so that the developing roller 9c is rotated. The developing blade 9d regulates a toner layer on the developing roller 9c. The developing container 12 supports the developing roller 9c. The developing blade 9d and the anti-blowoff sheet 14 are disposed at a circumference of the developing roller 9c, which is a rotating member. The developing blade 9d is formed of an elastic member such as rubber and secured to the developing container 12 with a first support member 9a, which is supported at a second securing portion 12b, interposed between the developing blade 9d and the developing container 12. According to the present embodiment, the developing blade 9d is disposed so as to be in contact with a surface of the developing roller 9c. Alternatively, the developing blade 9d may be disposed closed to the developing roller 9c with a gap formed therebetween. Furthermore, in order to prevent leakage of the toner from the developing container 12, the anti-blowoff sheet 14 is provided in the developing container 12 so as to be in contact with the developing roller 9c. The developer unit T is secured to the cleaning unit C such that the developing roller 9c faces the photosensitive drum 7.

### Detailed Description of the Developer Unit

The developing unit D includes the developing roller 9c, the developing blade 9d, and the developing container 12. The developing roller 9c is in contact with the photosensitive drum 7, so that the developing roller 9c can be rotated. The developing blade 9d regulates the toner layer on the developing roller 9c. The developing container 12, which serves as a frame body, supports the developing roller 9c. Furthermore, in order to prevent leakage of the toner from the developing container 12, the anti-blowoff sheet 14 is provided in the developing container 12 so as to be in contact with the developing roller 9c. The developer unit D is secured to the cleaning unit C such that the developing roller 9c faces the photosensitive drum 7. The toner container 11 that contains the toner supplied to the developing container 12 is connected to the developing unit D, thereby forming the developer unit T.

One end of the developing container 12 is connected to the toner container 11 and the other end of the developing container 12 has the opening 12d where the developing roller 9c is disposed. As illustrated in FIG. 3, the first support member 9a is provided on the other end side of the opening 12d. The developing blade 9d is secured to the first support member 9a in the longitudinal direction N. and the developing blade 9d extends in a lateral direction from one end side facing the opening to the rotating member side, that is, toward the developing roller 9c. The developing blade 9d is integrally formed with the first support member 9a or welded to the first support member 9a so as to be integrated with the first support member 9a.

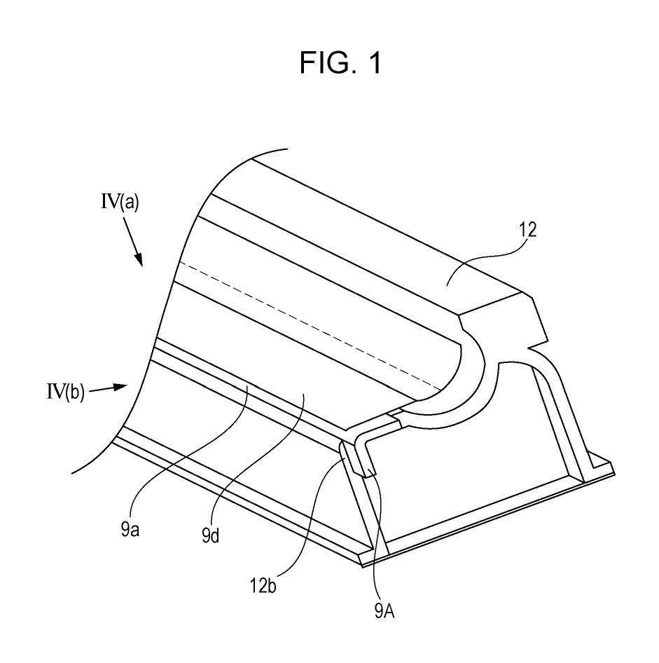

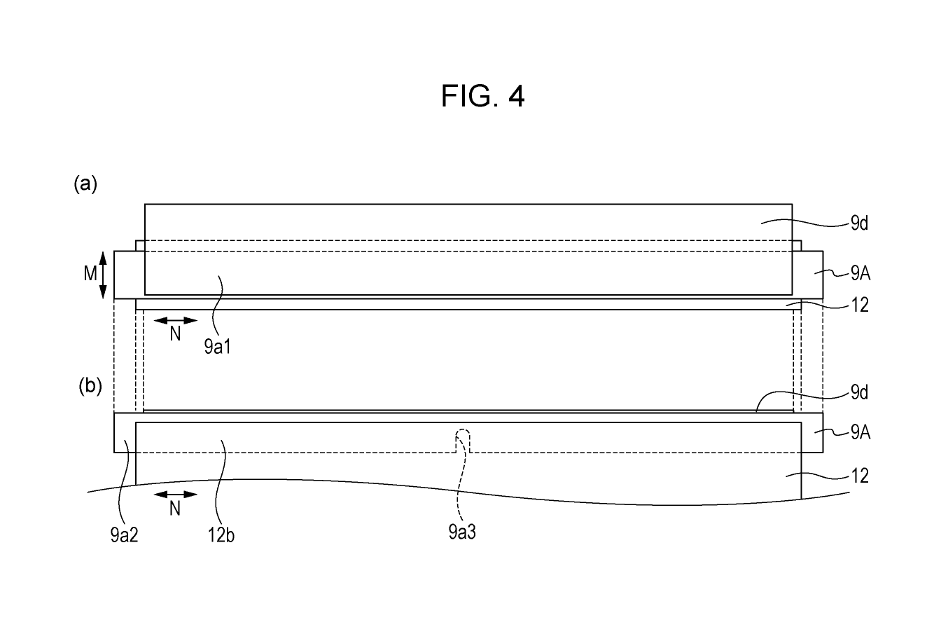

Referring to FIGS. 1 and 4, further details of the structure in which the first support member 9a and the developing blade 9d are attached to the developing container 12 are described. FIG. 1 is a perspective view of one end portion of the developing container 12. FIG. 4 includes views (a) and (b) illustrating the first support member 9a, the developing blade 9d, and a region close to the first support member 9a and the developing blade 9d. View (a) of FIG. 4 is a plan view of the developing blade 9d seen in the IV (a) direction indicated in FIG. 1 illustrating the developing blade 9d as an upper surface. View (b) of FIG. 4 is a plan view seen in the IV (b) direction indicated in FIG. 1 from the outer side of the developing container 12.

The first support member 9a is formed of a reinforcing member that extends in the longitudinal direction N. According to the present embodiment, a bent metal sheet that extends in the longitudinal direction N is used as the first support member 9a. More specifically, a steel material having an L-shaped section in the lateral direction M formed by a first plate portion 9a1 to which the developing blade 9d is secured and a second plate portion 9a2 is used as the first support member 9a. The first support member 9a is secured at the securing portion 12b of the developing container 12. The blade 9d is secured to the first plate portion 9a1 such that the blade 9d projects from a side of the first plate portion 9a1 connected to the second plate portion 9a2 toward a side opposite to the side of the first plate portion 9a1 connected to the second plate portion 9a2. That is, part of the second plate portion 9a2 of the first support member 9a is embedded in the developing container 12 so as to be clamped between a main body of the developing container 12 and the securing portion 12b of the developing container 12 in a thickness direction that intersects the longitudinal direction N of the second plate portion 9a2. Thus, the first support member 9a is supported by the developing container 12 and positioned relative to the developing container 12 in the lateral direction M. In this structure, an exposed portion 9A is formed so that least one of end portions of the first support member 9a in the longitudinal direction N is exposed from the developing container 12. According to the present embodiment, exposed portions 9A are formed so that both the ends of the second plate portion 9a2 of the first support member 9a in the longitudinal direction N are exposed from the developing container 12.

Furthermore, as illustrated in FIG. 4, a notch portion 9a3 can be provided in part of the first support member 9a embedded in the developing container 12. In this case, resin that forms the developing container 12 has flowed from the main body side or the securing portion 12b side of the developing container 12 into the notch portion 9a3 provided in the second plate portion 9a2. This allows the first support member 9a to be positioned relative to the developing container 12 in the longitudinal direction N. The shape of the notch portion 9a3 may be any one a circular hole, a long hole elongated in the lateral direction M, a recess, a shape having an opening at one end, and so forth. According to the present embodiment, the notch portion 9a3 is open at the side of the second plate portion 9a2 opposite to the side connected to the first plate portion 9l1. In this case, the width of the notch portion 9a3 can be equal to that of the opening or can decrease from the opening.

Bearing members that support a shaft of the developing roller 9c are provided on both ends of the developing container 12 in the longitudinal direction. Thus, the developing unit D has been formed.

### Effect 1

With the above-described structure, part of the first support member 9a is clamped between the main body of the developing container 12 and the securing portion 12b of the developing container 12. Thus, leakage of the developer to the outside of the developing container 12 can be prevented without using a seal member. In addition, the first support member 9a can be positioned relative to the developing container 12 in the lateral direction M.

Furthermore, the exposed portions 9A are formed so that the end portions of the first support member 9a in the longitudinal direction N are exposed from the developing container 12. Thus, expansion and contraction of the first support member 9a relative to the developing container 12 is tolerable.

In general, the coefficient of linear expansion (coefficient of thermal expansion), which represents the amount of expansion or contraction when subjected to heat, of metal is smaller than that of resin. Specifically, the coefficient of thermal expansion of a galvanized steel sheet used for the first support member 9a is 0.000015<1/° C.>. In contrast, the coefficient of thermal expansion of high impact polystyrene (HIPS) used for the developing container 12 is 0.000087<1/° C.>, which is significantly different from that of the galvanized steel sheet. Thus, when the first support member 9a and the developing container 12 are secured to each other at two or more positions in the longitudinal direction N in the related art, the cartridge B is deformed due to the difference in linear expansion (thermal expansion) between members included in the first support member 9a and the developing container 12. That is, when the temperature increases from room temperature, the developing container 12 side projects, and when the temperature decreases from room temperature, the first support member 9a side projects.

In contrast, according to the present embodiment, the developing container 12 can permit a movement of the first support member 9a in the longitudinal direction N while regulating a movement of the first support member 9a in the lateral direction. Accordingly, bending or deformation of the first support member 9a, the developing blade 9d secured to the first support member 9a, and the developing container 12 caused by changes in room temperature can be suppressed. That is, according to the present embodiment in which the developing blade 9d and the developing roller 9c are in contact with each other, the occurrence of the difference in contact pressure at which the developing blade 9d and the developing roller 9c are in contact with each other in the longitudinal direction N of the developing roller 9c can be suppressed. In the case where the developing blade 9d and the developing roller 9c are disposed closed to each other with the gap therebetween, changes in the size of the gap can be reduced. As a result, the likelihood of being affected by heat can be easily reduced with a small number of components instead of increasing the number of components.

Furthermore, the notch portion 9a3 is provided the in the part of the first support member 9a embedded in the developing container 12. The resin that forms the developing container 12 has flowed from the main body side or the securing portion 12b side of the developing container 12 into the notch portion 9a3 of the first support member 9a so as to be engaged with the notch portion 9a3. As a result, the first support member 9a can be positioned relative to the developing container 12 in the longitudinal direction N.

Furthermore, in the structure according to the present embodiment, the first support member 9a is not screwed or bonded to the developing container 12, and the notch portion 9a3 provided in the first support member 9a is open to an end surface extending in the longitudinal direction N. Thus, an easily recyclable structure can be obtained.

### A Method of Producing the Developing Unit 1

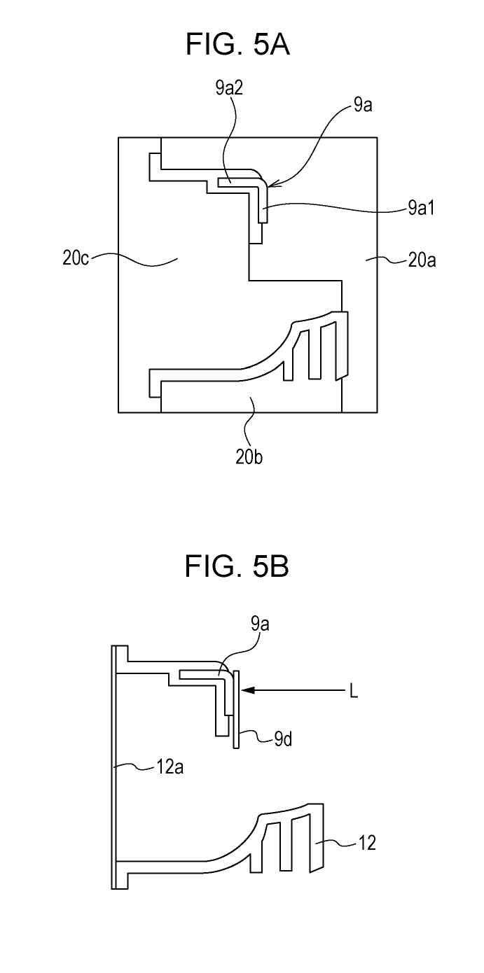

A method of producing the above-described developing unit D is described below with reference to FIGS. 5A and 5B. As illustrated in FIG. 5A, the production method is described with an example of a method of forming in which the developing container 12 is integrally molded with the first support member 9a by using a mold 20 that includes a fixed part 20a and movable parts 20b and 20c. Initially, the first support member 9a is prepared and secured to the fixed part 20a. Then, the movable parts 20b and 20c are set in the fixed part 20a, and molten resin used to form the developing container 12 is injected into a space 23 having been formed. Thus, the developing container 12 is formed. More specifically, the developing container 12 is formed without embedding both the ends of the first support member 9a in the longitudinal direction N and the first plate portion 9a in the molten resin. Thus, the exposed portions 9A are provided at both the end portions of the first support member 9a in the longitudinal direction N. Meanwhile, part of the second plate portion 9a2 of the first support member 9a is secured so as to project into the space 23 of the mold 20 when the molten resin used to form the developing container 12 is injected into the mold 20. Thus, the second plate portion 9a2 of the first support member 9a is embedded in the developing container 12. By performing insert molding as described above, the first support member 9a is secured to the developing container 12. The notch portion 9a3 can be provided in the part of the first support member 9a embedded in the developing container 12. Thus, the resin that forms the developing container 12 flows from the main body side or the securing portion 12b side of the developing container 12 into the notch portion 9a3 of the second plate portion 9a2. As a result, the first support member 9a can be positioned relative to the developing container 12 in the longitudinal direction N.

The developing container 12 may be formed of any type of thermosetting resin or thermoplastic resin that can be processed by injection molding. For example, a styrenic resin composition that contains at least styrenic resin as base material resin and a rubber-like polymer may be used. Although examples of the styrenic resin contained in the styrenic resin composition include, for example, polystyrene and acrylonitrile butadiene styrene (ABS), use of polystyrene is desirable. Examples of the rubber-like polymer contained in the styrenic resin compound include, for example, polybutadiene, a styrene-butadiene copolymer, polyisoprene, a butadiene-isoprene copolymer, natural rubber, an ethylene-propylene copolymer, and a combination of these. As the rubber-like polymer contained in the styrenic resin compound, use of a high styrene-butadiene copolymer is particularly desirable. A styrenic resin compound that contains styrenic resin and a rubber-like polymer may be referred to as HIPS, which is a rubber-modified styrenic material. HIPS is a resin composition made by mixing polystyrene (PS) that is cheap and has good fluidity with a rubber-like polymer (including a rubber-like copolymer) so as to have improved shock resistance. Thus, use of the HIPS is desirable. Thus, the developing container 12 according to the present embodiment is formed of HIPS.

As illustrated in FIG. 5B, after the developing blade 9d formed of, for example, stainless steel, has been disposed on the first support member 9a secured to the developing container 12, a laser light L is radiated so as to secured the developing blade 9d to the first support member 9a. A developing container lid 12a is joined to the developing container 12 by, for example, ultrasonic welding. At last, the shaft of the developing roller 9c is supported by the bearing members (not illustrated) provided at both the ends of the developing container 12 in the longitudinal direction N such that the tip end of the developing blade 9d is disposed on the developing roller 9c, which is the rotating member. The developing unit D is thus formed. Alternatively, bearing portions may be provided in the developing container 12, so that both the ends of the shaft of the developing roller 9c in the longitudinal direction N are supported by the bearing portions of the developing container 12.

### Effect 2

With the structure according to the above-described embodiment, leakage of the developer to the outside of the developing container 12 can be prevented without using the seal member between the first support member 9a and the main body of the developing container 12. Thus, a production process can be further simplified. Furthermore, the movement of the first support member 9a relative to the developing container 12 is regulated in the lateral direction and permitted in the longitudinal direction N by the exposed portions 9A in the developing unit D produced by the method according to the present embodiment. Accordingly, bending or deformation of the first support member 9a, the developing blade 9d secured to the first support member 9a, and the developing container 12 caused by changes in room temperature can be suppressed. That is, according to the present embodiment in which the developing blade 9d and the developing roller 9c are in contact with each other, the occurrence of the difference in contact pressure at which the developing blade 9d and the developing roller 9c are in contact with each other in the longitudinal direction N of the developing roller 9c can be suppressed. In the case where the developing blade 9d and the developing roller 9c are disposed close to each other with the gap therebetween, changes in the size of the gap can be reduced. As a result, the likelihood of being affected by heat can be easily reduced with a small number of components instead of increasing the number of components.

Furthermore, the notch portion 9a3 is provided in the part of the first support member 9a embedded in the developing container 12. The resin that forms the developing container 12 has flowed from the main body side or the securing portion 12b side of the developing container 12 into the notch portion 9a3 of the first support member 9a. As a result, the first support member 9a can be positioned relative to the developing container 12 in the longitudinal direction N. Furthermore, the first support member 9a is not screwed or bonded to the developing container 12, and the notch portion 9a3 provided in the first support member 9a is open to the end surface extending in the longitudinal direction N. Thus, in addition to make production easier, an easily recyclable structure can be obtained.

### Second Embodiment

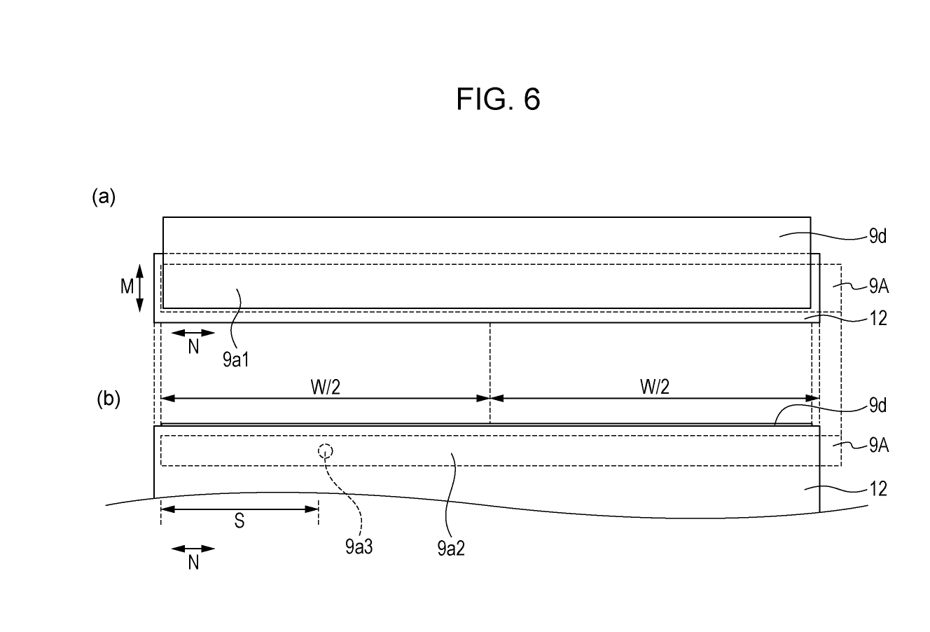

According to the first embodiment, the exposed portions 9A at both the ends of the first support member 9a in the longitudinal direction N and the first plate portion 9al are not embedded in the molten resin used to form the developing container 12. However, this is not limiting. As illustrated in FIG. 6, a structure is possible in which one of the end portions of the first support member 9a in the longitudinal direction N is not embedded in the molten resin used to form the developing container 12. In this case, a cushion member may be disposed at the one of the end portions of the first support member 9a so that the first support member 9a, the cushion member, and the developing container 12 are sequentially arranged in the longitudinal direction N. Furthermore, not only the second plate portion 9a2 but also the first plate portion 9a of the first support member 9a may be embedded in the molten resin used to form the developing container 12. In this case, the developing blade 9d is secured to the first plate portion 9a1 with the developing container 12 interposed therebetween. The notch portion 9a3 may be provided also according to the present embodiment. In this case, the notch portion 9a3 may be provided in the second plate portion 9a2 or in the part of the first support member 9a embedded in the developing container 12 such as the first plate portion 9a1 instead of the second plate portion 9a2. The notch portion 9a3 is formed such that a shortest distance S between an end portion of the notch portion 9a3 and the other end portion of the first support member 9a embedded in the molten resin in the longitudinal direction N is less than half a length W, by which the first support member 9a is embedded in the molten resin. That is, the distance S is less than half a length that is calculated by subtracting the length of the exposed portion 9A from the length of the first support member 9a. According to the present embodiment, a circular hole serving as the notch portion 9a3 is provided at a position one fourth of the length W, by which the first support member 9a is embedded in the molten resin, away from the other end portion of the first support member 9a. FIG. 6 includes views (a) and (b) illustrating the first support member 9a, the developing blade 9d, and a region close to the first support member 9a and the developing blade 9d. View (a) of FIG. 6 is a plan view of the developing blade 9d illustrating the developing blade 9d as an upper surface. View (b) of FIG. 6 is a plan view seen from the outer side of the developing container 12.

With the structure according to the present embodiment, as is the case with the first embodiment, the developing container 12 can permit the movement of the first support member 9a in the longitudinal direction N while regulating the movement of the first support member 9a in the lateral direction. This can suppress deformation of the process cartridge B caused by the difference in linear expansion (thermal expansion) between members included in the developing container 12 and the first support member 9a. That is, bending or deformation of the first support member 9a, the developing blade 9d secured to the first support member 9a, and the developing container 12 caused by changes in room temperature can be suppressed. According to the present embodiment in which the developing blade 9d and the developing roller 9c are in contact with each other, the occurrence of the difference in contact pressure at which the developing blade 9d and the developing roller 9c are in contact with each other in the longitudinal direction N of the developing roller 9c can be suppressed. In the case where the developing blade 9d and the developing roller 9c are disposed close to each other with the gap therebetween, changes in the size of the gap can be reduced. As a result, the likelihood of being affected by heat can be easily reduced with a small number of components instead of increasing the number of components.

In the related art, when the first support member 9a that reinforces the developing container 12 and the developing blade 9d are disposed in the developing container 12, the developing blade 9d cannot be secured to the developing container 12 with good positional accuracy due to errors in steps of assembling the members. However, according to the present embodiment, the developing blade 9d is directly secured to the developing container 12. Thus, the developing blade 9d can be secured to the developing container 12 with good positional accuracy.

Furthermore, the notch portion 9a3 is provided in the part of the first support member 9a embedded in the developing container 12. The resin that forms the developing container 12 has flowed from the main body side or the securing portion 12b side of the developing container 12 into the notch portion 9a3. This allows the first support member 9a to be positioned relative to the developing container 12 in the longitudinal direction N.

The invention according to the present embodiment can be produced in a method similar to that of the first embodiment, and the effects similar to those in the first embodiment can be obtained.

### Third Embodiment

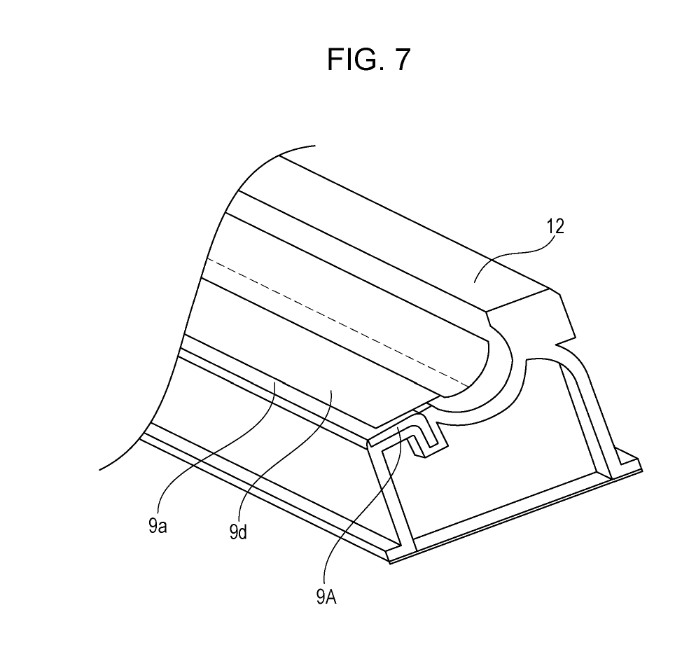

According to the first embodiment, the first support member 9a is secured at the securing portion 12b of the developing container 12, and the developing blade 9d is secured to the first plate portion 9a1 such that the developing blade 9d projects from the side of the first plate portion 9a1 connected to the second plate portion 9a2 toward the side opposite to the side of the first plate portion 9a1 connected to the second plate portion 9a2. However, this is not limiting. As illustrated in FIG. 7, the developing blade 9d may be secured to the first plate portion 9a1 of the first support member 9a such that the developing blade 9d projects from the side opposite to the side where the first plate portion 9a1 and the second plate portion 9a2 of the first support member 9a are connected to each other toward the side where the first plate portion 9a1 and the second plate portion 9a2 are connected to each other. Also, as illustrated in FIG. 7, it is sufficient that the exposed portion 9A may be formed by exposing an end surface in the longitudinal direction N. The end portion or the end portions of the first support member 9a do not necessarily project in the longitudinal direction N as described in the first or second embodiment. With this structure, the effects similar to those of the first embodiment can be obtained.

The invention according to the present embodiment can be produced in a method similar to that of the first embodiment, and the effects similar to those in the first embodiment can be obtained.

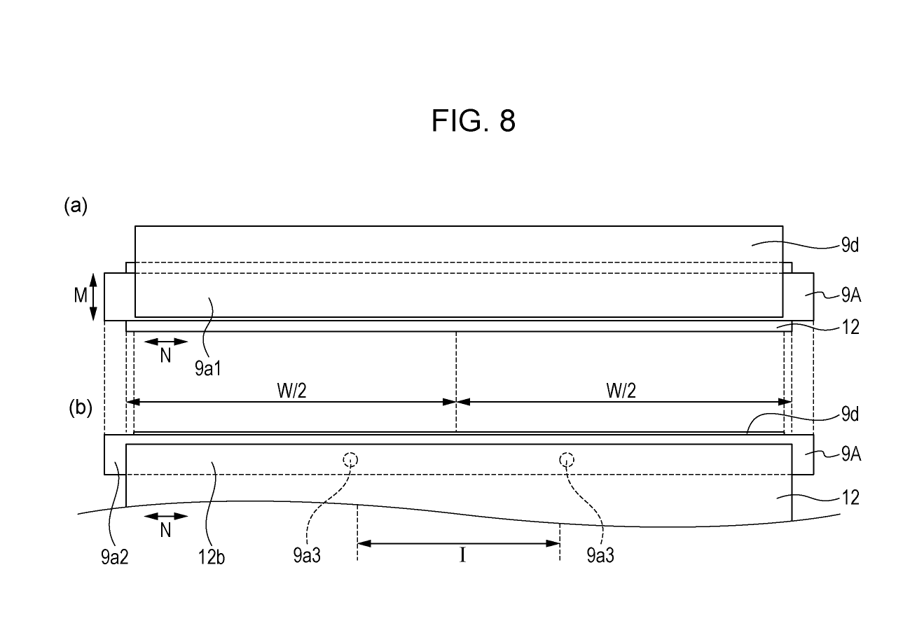

According to the first to third embodiments, a single notch portion 9a3 is provided. However, this is not limiting. A plurality of notch portions 9a3 as illustrated in FIG. 8 may be provided. In this case, a shortest interval I between the end portions of the notch portions 9a3 is less than half the length W, by which the first support member 9a is embedded in the molten resin, that is, the length calculated by subtracting the length of the exposed portions 9A from the length of the first support member 9a. FIG. 8 includes views (a) and (b) illustrating the first support member 9a, the developing blade 9d, and a region close to the first support member 9a and the developing blade 9d. View (a) of FIG. 8 is a plan view of the developing blade 9d illustrating the developing blade 9d as an upper surface. View (b) of FIG. 8 is a plan view seen from the outer side of the developing container 12. Referring to FIG. 8, the distance I between the notch portions 9a3 is one third of the length W, by which the first support member 9a is embedded in the molten resin, and each of the notch portions 9a3 has a circular shape.

Although a steel material having an L-shaped section in the lateral direction M is used as the first support member 9a, the first support member 9a is not limited to this. Any reinforcing member may be used as the first support member 9a. For example, a plate-shaped or rod-shaped steel material may be used as the first support member 9a.

Although the developing blade 9d is secured to the first support member 9a after the first support member 9a has been integrated with the developing container 12, this is not limiting. For example, the first support member 9a to which the developing blade 9d has been secured in advance may be used. Also, the first support member 9a and the developing blade 9d may be integrated with each other.

### Fourth Embodiment

According to the first to third embodiments, the present invention is applied to the structure with which the developing blade 9d is secured in the developing unit D. In a fourth embodiment, the present invention is applied to a structure with which the support member that supports the cleaning blade is secured in the cleaning unit. The structure according to the fourth embodiment is similar to the entire structure of the image forming apparatus and the outline of the entirety of the cartridge of the first embodiment. Thus, the difference between the first embodiment and the fourth embodiment is mainly described below.

### Detailed Description of the Cleaning Unit

The cleaning container 13 has an opening disposed such that the photosensitive drum 7 faces the opening. As illustrated in FIG. 3, the second support member 10c is provided in the opening. The cleaning blade 10a is secured to the second support member 10c in the longitudinal direction N, and the cleaning blade 10a extends in a lateral direction from one end side facing the opening to the rotating member side, that is, toward the photosensitive drum 7. The cleaning blade 10a is integrally formed with the second support member 10c or welded to the second support member 10c so as to be integrated with the second support member 10c.

The second support member 10c is formed of a reinforcing member that extends in the longitudinal direction N. According to the present embodiment, a bent metal sheet that extends in the longitudinal direction N is used as the second support member 10c. That is, a steel material having an L-shaped section in the lateral direction M formed by a third plate portion 10a1 to which the cleaning blade 10a is secured and a fourth plate portion 10a2 is used as the second support member 10c. The second support member 10c is secured at a securing portion of the cleaning container 13. The cleaning blade 10a is secured to the third plate portion 10a1 such that the cleaning blade 10a projects from a side of the third plate portion 10a1 connected to the fourth plate portion 10a2 toward a side opposite to the side of the third plate portion 10a1 connected to the fourth plate portion 10a2. More specifically, part of the fourth plate portion 10a2 of the second support member 10c is embedded in the cleaning container 13 so as to be clamped between a main body of the cleaning container 13 and the securing portion of the cleaning container 13 in a thickness direction that intersects the longitudinal direction N of the fourth plate portion 10a2. Thus, the second support member 10c is supported by the cleaning container 13 and positioned relative to the cleaning container 13 in the lateral direction M. In this structure, exposed portions are formed so that end portions of the second support member 10c in the longitudinal direction N are exposed from the cleaning container 13. According to the present embodiment, both ends of the second support member 10c in the longitudinal direction N are exposed from the cleaning container 13.

Furthermore, a notch portion can be provided in part of the second support member 10c embedded in the cleaning container 13. In this case, resin that forms the cleaning container 13 has flowed from the main body side or the securing portion side of the cleaning container 13 into the notch portion of the fourth plate portion 10a2. This allows the second support member 10c to be positioned relative to the cleaning container 13 in the longitudinal direction N. The shape of the notch portion may be any one a circular hole, a long hole elongated in the lateral direction M, a recess, a shape having an opening at one end, and so forth. According to the present embodiment, the notch portion is open at the side of the fourth plate portion 10a2 opposite to the side connected to the third plate portion 10a1. In this case, the width of the notch portion can be equal to that of the opening or can decrease from the opening.

Bearing members that support a shaft of the photosensitive drum 7 are provided on both ends of the cleaning container 13 in the longitudinal direction. Thus, the cleaning unit C has been formed. Alternatively, bearing portions may be provided in the cleaning container 13, so that both the ends of the shaft of the photosensitive drum 7 in the longitudinal direction N are supported by the bearing portions of the cleaning container 13.

### Effect 3

With the above-described structure, part of the second support member 10c is clamped between the main body of the cleaning container 13 and the securing portion of the cleaning container 13. Thus, leakage of the developer to the outside of the cleaning container 13 can be prevented without using a seal member. This also allows the second support member 10c to be positioned relative to the cleaning container 13 in the lateral direction M.

Furthermore, the exposed portions are formed so that the end portions of the second support member 10c in the longitudinal direction N are exposed from the cleaning container 13. Thus, the cleaning container 13 can permit a movement of the second support member 10c in the longitudinal direction N while regulating a movement of the second support member 10c in the lateral direction. That is, expansion and contraction of the second support member 10c relative to the cleaning container 13 is tolerable. Accordingly, bending or deformation of the second support member 10c, the cleaning blade 10a secured to the second support member 10c, and the cleaning container 13 caused by changes in room temperature can be suppressed. According to the present embodiment in which the cleaning blade 10a and the photosensitive drum 7 are in contact with each other, the occurrence of the difference in contact pressure at which the cleaning blade 10a and the photosensitive drum 7 are in contact with each other in the longitudinal direction N of the photosensitive drum 7 can be suppressed. As a result, the likelihood of being affected by heat can be easily reduced with a small number of components instead of increasing the number of components.

Furthermore, the notch portion is provided in the part of the second support member 10c embedded in the cleaning container 13. The resin that forms the cleaning container 13 has flowed from the main body side or the securing portion side of the cleaning container 13 into the notch portion of the second support member 10c. As a result, the second support member 10c can be positioned relative to the cleaning container 13 in the longitudinal direction N.

Furthermore, the second support member 10c is not screwed or bonded to the cleaning container 13, and the notch portion provided in the second support member 10c is open to an end surface extending in the longitudinal direction N. Thus, an easily recyclable structure can be obtained.

### A Method of Producing the Cleaning Unit

A method of producing the above-described cleaning unit C is described below. As is the case with the first embodiment, the production method is described with an example of a method of forming in which the cleaning container 13 is integrally molded with the second support member 10c by using a mold. Initially, the second support member 10c in which the cleaning blade 10a has been formed at an end portion of the third plate portion 10a1 is prepared and set in the mold. After that, molten resin used to form the cleaning container 13 is injected into the mold, thereby forming the cleaning container 13. More specifically, the cleaning container 13 is formed without embedding both the ends of the second support member 10c in the longitudinal direction N and the cleaning blade 10a in the molten resin used to form the cleaning container 13. Thus, the exposed portions are provided at both the end portions of the second support member 10c in the longitudinal direction N. Meanwhile, part of the fourth plate portion 10a2 of the second support member 10c is secured so as to project into a space of the mold when the molten resin used to form the cleaning container 13 is injected into the mold. Thus, the fourth plate portion 10a2 of the second support member 10c is embedded in the cleaning container 13. By performing insert molding as described above, the second support member 10c is secured to the cleaning container 13. The notch portion can be provided in the part of the second support member 10c embedded in the cleaning container 13. Thus, the resin that forms the cleaning container 13 flows from the main body side or the securing portion side of the cleaning container 13 into the notch of the fourth plate portion 10a2. As a result, the second support member 10c can be positioned relative to the cleaning container 13 in the longitudinal direction N.

The cleaning container 13 may be formed of any type of thermosetting resin or thermoplastic resin that can be processed by injection molding. For example, a styrenic resin composition that contains at least styrenic resin as base material resin and a rubber-like polymer may be used. Although examples of the styrenic resin contained in the styrenic resin composition include, for example, polystyrene and acrylonitrile butadiene styrene (ABS), use of polystyrene is desirable. Examples of the rubber-like polymer contained in the styrenic resin compound include, for example, polybutadiene, a styrene-butadiene copolymer, polyisoprene, a butadiene-isoprene copolymer, natural rubber, an ethylene-propylene copolymer, and a combination of these. As the rubber-like polymer contained in the styrenic resin compound, use of a high styrene-butadiene copolymer is particularly desirable. A styrenic resin compound that contains styrenic resin and a rubber-like polymer may be referred to as HIPS, which is a rubber-modified styrenic material. HIPS is a resin composition made by mixing polystyrene (PS) that is cheap and has good fluidity with a rubber-like polymer (including a rubber-like copolymer) so as to have improved shock resistance. Thus, use of the HIPS is desirable. Thus, the cleaning container 13 according to the present embodiment is formed of HIPS.

The shaft of the photosensitive drum 7 is supported by the bearing members (not illustrated) provided at both the ends of the cleaning container 13 in the longitudinal direction N such that the tip end of the cleaning blade 10a is disposed on the photosensitive drum 7 that is the rotating member. The cleaning unit C is thus formed.

### Effect 4

With the structure according to the above-described embodiment, leakage of the developer to the outside of the cleaning container 13 can be prevented without using the seal member between the second support member 10c and main body of the cleaning container 13. Thus, a production process can be further simplified. Furthermore, the movement of the second support member 10c relative to the cleaning container 13 is regulated in the lateral direction and permitted in the longitudinal direction N by the exposed portion in the cleaning unit C produced by the method according to the present embodiment. Accordingly, bending or deformation of the second support member 10c, the cleaning blade 10a secured to the second support member 10c, and the cleaning container 13 caused by changes in room temperature can be suppressed. According to the present embodiment in which the cleaning blade 10a and the photosensitive drum 7 are in contact with each other, the occurrence of the difference in contact pressure at which the cleaning blade 10a and the photosensitive drum 7 are in contact with each other in the longitudinal direction N of the photosensitive drum 7 can be suppressed. As a result, the likelihood of being affected by heat can be easily reduced with a small number of components instead of increasing the number of components.

Furthermore, the notch portion is provided in the part of the second support member 10c embedded in the cleaning container 13. The resin that forms the cleaning container 13 has flowed from the main body side or the securing portion side of the cleaning container 13 into the notch portion of the second support member 10c. As a result, the second support member 10c can be positioned relative to the cleaning container 13 in the longitudinal direction N.

Furthermore, the second support member 10c is not screwed or bonded to the cleaning container 13, and the notch portion provided in the second support member 10c is open to an end surface extending in the longitudinal direction N. Thus, in addition to make production easier, an easily recyclable structure can be obtained.

Although the second support member 10c to which the cleaning blade 10a is secured in advance is used in the above-described embodiment, this is not limiting. For example, as is the case with the first embodiment, the cleaning blade 10a may be secured to the second support member 10c after the second support member 10c is integrated with the cleaning container 13. Alternatively, the cleaning blade 10a may be integrated with the second support member 10c. Also in the structure according to the present embodiment, changes similar to those of the second and third embodiments made to the first embodiment may be made to the present embodiment, and the effects similar to those produced by the second and third embodiments can be obtained.

### Fifth Embodiment

According to the first to third embodiments, the support member 9a is secured to the fixed part 20a, the movable parts 20b and 20c are set in the fixed part 20a, and then the molten resin used to form the developing container 12 is injected into a space 23 having been formed. Thus, the developing container 12 is formed. At this time, in order to secure the first support member 9a to the fixed part 20a, both the end portions of the first support member 9a in the longitudinal direction are supported. However, the position of the first support member 9a relative to the fixed part 20a may be deviated by a pressure of the resin applied when the molten resin used to form the developing container 12 is injected. Thus, as a fifth embodiment, the developing unit with which the deviation of the position of the first support member 9a relative to the fixed part 20a is suppressed and a method of producing this developing unit will be described below. The structure according to the fifth embodiment is also similar to the entire structure of the image forming apparatus and the outline of the entirety of the cartridge of the first embodiment. Thus, the difference between the first embodiment and the fifth embodiment is mainly described below.

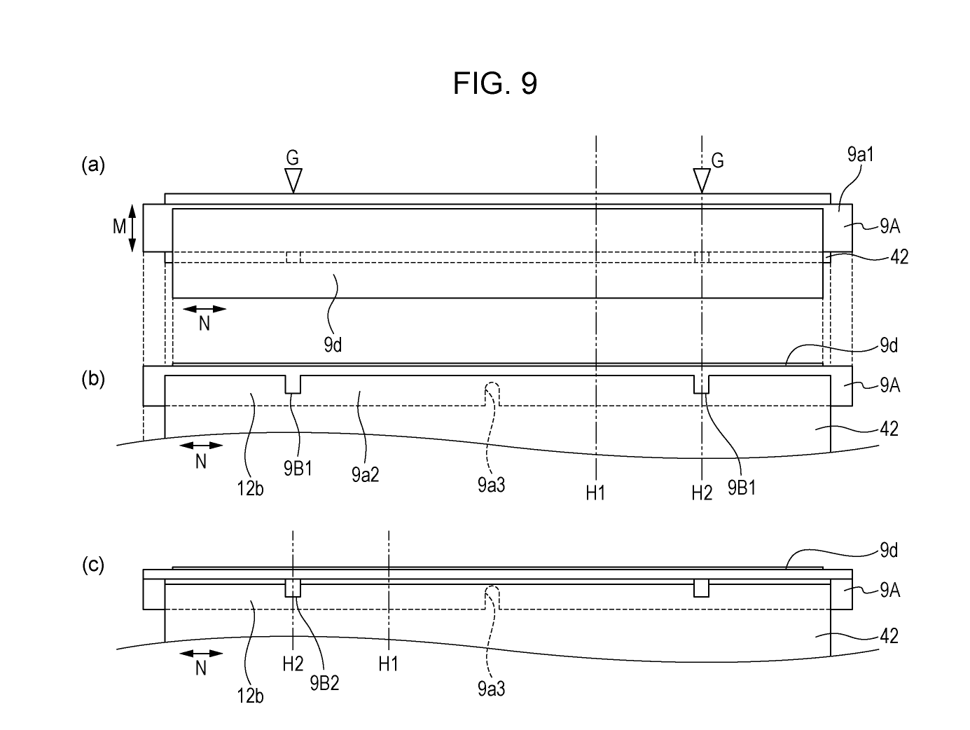

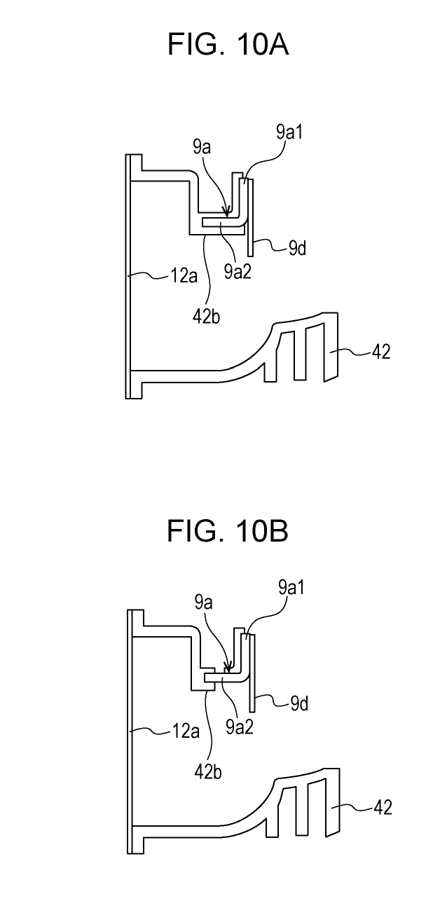

FIG. 9 includes views (a), (b), and (c) that are respectively a top view, an inner side view, and an outer side view of the developing container 42. FIGS. 10A and 10B are sectional views of the developing container 42 respectively illustrating sections H1 and H2 illustrated in FIG. 9. Also according to the present embodiment, as is the case with the first embodiment, the first support member 9a having an L-shaped section in the lateral direction M formed by the first plate portion 9a1 to which the developing blade 9d is secured and the second plate portion 9a2 is used. The second plate portion 9a2 of the first support member 9a is embedded in a securing portion 42b of the developing container 42 so as to be secured to the developing container 42, and the developing blade 9d is secured to the first plate portion 9a1 of the first support member 9a. In this state, according to the present embodiment, the developing blade 9d is secured to the first plate portion 9a1 such that the tip end of the developing blade 9d projects toward the side of the first plate portion 9a1 connected to the second plate portion 9a2. That is, the first support member 9a is disposed such that the side of the first plate portion 9al opposite to the side connected to the second plate portion 9a2 faces the outer side of the developing container 42.

More specifically, as illustrated in FIGS. 9 to 10B, a plurality of exposure portions 9B and a plurality of exposure portions 9B2, at which the second plate portion 9a2 of the first support member 9a are exposed from the developing container 42, are provided. The second plate portion 9a2 is exposed from the developing container 42 at the exposure portions 9B1 when seen from a direction facing the tip of the developing blade 9d. The exposure portions 9B1 each have a notch shape open to the side of the second plate portion 9a2 connected to the first plate portion 9a1. The positions of the exposure portions 9B1 and 9B2 are superposed on those of gate portions G, through which the molten resin is injected, in the lateral direction that intersects the longitudinal direction N of the developing container 42.

The second plate portion 9a2 is exposed from the developing container 42 at the exposure portions 9B2 when seen from a direction facing the side of the first plate portion 9a1 directed to the outer side. The exposure portions 9B2 are through holes that are open toward the outer side.

Other part of the second plate portion 9a2 where neither the exposure portions 9B1 nor the 9B2 of the developing container 42 are provided in the longitudinal direction are, as illustrated in FIG. 9 and FIG. 10B, clamped by the developing container 42 and firmly secured.

Furthermore, as is the case with the first embodiment, the exposed portions 9A are formed so that both the ends of the first support member 9a in the longitudinal direction N are exposed from the developing container 42. Furthermore, the notch portion 9a3 is provided in the part of the first support member 9a embedded in the developing container 42. The resin that forms the developing container 42 has flowed into the notch portion 9a3.

### A Method of Producing the Developing Unit 2

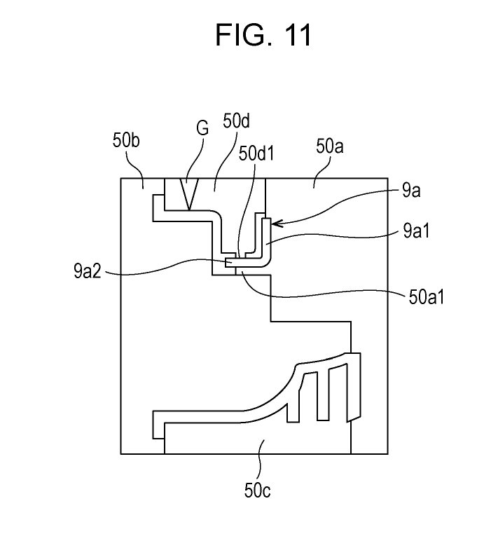

A method of producing the above-described developing container 42 is described below with reference to FIG. 11. The production method is described with an example of a method of forming in which the developing container 42 is integrally molded with the first support member 9a by using a mold 50 that includes a fixed part 50a and movable parts 50b, 50c, and 50d.

Initially, the first support member 9a is prepared and secured to the fixed part 50a. Then, the movable parts 50b, 50c and 50d are set in the fixed part 50a, and molten resin used to form the developing container 42 is injected into a space 43 having been formed. Thus, the developing container 42 is formed. More specifically, when the first support member 9a is set in the mold 50, the first support member 9a is supported by, for example, magnetic attraction or air suction so that the first plate portion 9a1 of the first support member 9a is brought into contact with and supported by first receiving portions 50a1 of the mold 50. Next, the movable parts 50b, 50c, and 50d is set in the fixed part 50a so as to be in contact with the fixed part 50a, thereby forming the space 43 in the mold 50. At this time, the first support member 9a is also supported by the first receiving portions 50a1 of the fixed part 50a and second receiving portions 50d 1 of the movable part 50d so that the first support member 9a is clamped between the first receiving portions 50a1 and the second receiving portions 50d1.

Then, the molten resin is injected into the space 43 of the mold 50 through a gate portion G provided in the movable part 50d with the first support member 9a set in (inserted into) the mold 50. The molten resin injected through the gate portion G reaches various parts in the mold 50 at different times in accordance with the distances from the gate portion G. The distance between the gate portion G and the first support member 9a is the shortest in a section that intersects the longitudinal direction N of the first support member 9a (developing container 42). Thus, the position of the first support member 9a may be deviated by the molten resin flowing first to the first support member 9a corresponding to the position in the lateral direction of the gate portion G.

However, according to the present embodiment, injection molding can be performed while the first support member 9a is supported by the first receiving portions 50a1 of the fixed part 50a and the second receiving portions 50d1 of the movable part 50d in the section that intersects the longitudinal direction of the first support member 9a (developing container 42).

After the resin has been injected, the developing container 42 into which the first support member 9a has been inserted is released from the mold 50. The parts supported by the first receiving portions 50a1 and the second receiving portions 50d1 respectively become the exposure portions 9B1 and 9B2 at which the first support member 9a is exposed.

### Effect 5

With the structure according to the above-described embodiment, the pressure applied to the first support member 9a by the molten resin injected through the gate portion G can be supported by the first receiving portions 50a1 and the second receiving portions 50d1. As a result, by efficiently performing insert molding, the first support member 9a can be firmly secured while embedded in the developing container 42 with improved positional accuracy realized by suppressing positional deviation. By stably supporting the support member in the mold during injection of the resin as described above, variation in injection of the resin during molding can also be suppressed and stable formability can be realized. In addition, the blade secured to the support member can be attached with good accuracy.

The widths of the exposure portions 9B1 in the longitudinal directions are the same, and widths of the exposure portions 9B2 in the longitudinal direction N are the same. The shape of each of the exposure portions 9B1 is symmetric about a center line of a corresponding one of the gate portions G at the center of the gate portion G in the longitudinal direction N, and the shape of each of the exposure portions 9B2 are symmetric about a center line of a corresponding one of the gate portions G at the center of the gate portion G in the longitudinal direction N. However, the exposed portions 9B1 and 9B2 are not limited to these. It is sufficient that the exposure portions 9B1 and 9B2 be superposed on the respective gate portions G in the sections that intersect the longitudinal direction N. The exposure portions 9B1 are not necessarily symmetric about a center line of the second plate portion 9a2 at the center of the second plate portion 9a2 in the longitudinal direction N, and the exposure portions 9B2 are not necessarily symmetric about a center line of the second plate portion 9a2 at the center of the second plate portion 9a2 in the longitudinal direction N.

Although the exposure portions 9B1 and 9B2 are partially provided according to the above-described embodiment, this in not limiting. Specifically, according to the above-described embodiment, the exposure portions 9B1 and 9B2 are provided so as to correspond to the positions of the gate portions G in the lateral direction in the sections that intersect the longitudinal direction N of the first support member 9a (developing container 42). However, the exposure portions 9B1 and 9B2 may be provided such that the first support member 9a is exposed through the longitudinal direction N with ends of the second plate portion 9a2 of the first support member 9a secured to the developing container 42. Alternatively, depending on the shape of the mold, one of surfaces of the first plate portion 9a1 of the first support member 9a may be supported by magnetic attraction, air suction, or the like and the other surface of the first plate portion 9a1 may be pressed against the receiving portions provided in the mold. In this case, at least one of the surfaces of the first plate portion 9a1 may be exposed through an exposed portion or exposed portions.

### Sixth Embodiment

According to the fifth embodiment, the exposure portions 9B1 and 9B2 correspond to the positions of the gate portions G. However, the structures and positions of the exposure portions are not limited to this. Hereafter, the structure of a sixth embodiment is described mainly by describing the differences between the sixth embodiment and first and fifth embodiments. The structure according to the sixth embodiment is also similar to the entire structure of the image forming apparatus and the outline of the entirety of the cartridge of the first embodiment.

In the case where the first support member 9a is insert molded, a developing container 52 may be bent after the developing container 52 has been molded. Thus, a structure that suppresses such bending is described.

Initially, how such bending occurs is described. In general, shrinkage referred to as mold shrinkage occurs in resin molded components (components molded by, for example, injection molding) such as a developing container immediately after the molding has been performed. At this time, by a shrinkage force of the resin around the first support member 9a, adhesion between the developing container formed of the resin and the first support member increases. Thus, slipping at an interface between the developing container and the first support member is obstructed. As a result, when the difference in linear expansion (thermal expansion) between the first support member 9a formed of metal and the developing container 52 formed of resin is large, the cartridge B is deformed by accumulated stress.

In order to address this, exposure portions are provided so as to reduce the widths of respective contact portions where the first support member 9a and the developing container 52 are in contact with each other in the longitudinal direction N of the first support member 9a, so that stress accumulated in the first support member 9a and the developing container 52 is reduced. As a result, stress caused by the difference in linear expansion (thermal expansion) between the first support member formed of metal and the developing container formed of resin can be reduced in the exposure portions, and accordingly, the deformation of the cartridge B can be suppressed.

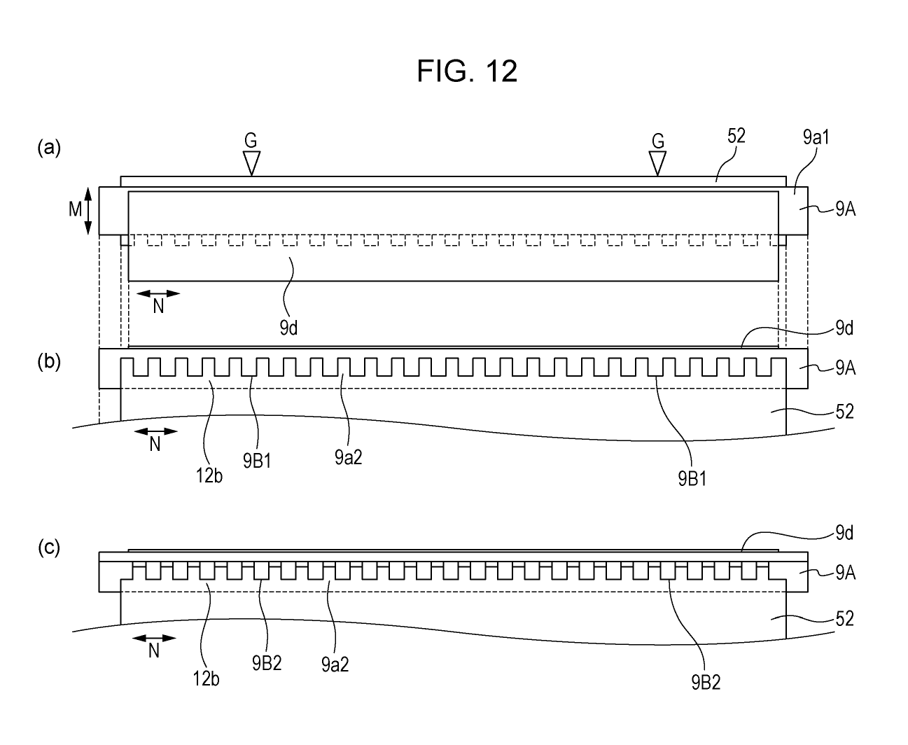

Specifically, exposure portions 9B1 and exposure portions 9B2 are respectively provided in an outer side surface (view (b) of FIG. 12) and an inner side surface (view (c) of FIG. 12) of the second securing portion 12b of the developing container 52, which supports the first support member 9a, such that the row of the exposure portions 9B1 and the row of the exposure portions 9B2 are staggered with respect to each other in the longitudinal direction N. That is, in sections in directions that intersect the longitudinal direction N of the developing container 52, the first support member 9a is not clamped by the resin of the developing container 52. This can reduced the adhesion between the developing container 52 and the first support member 9a. In addition, a plurality of the exposure portions 9B1 and a plurality of the exposure portions 9B2 are provided in the longitudinal direction N in the outer side surface and the inner side surface of the second securing portion 12b of the developing container 52, respectively. Thus, the stress can be further reduced.

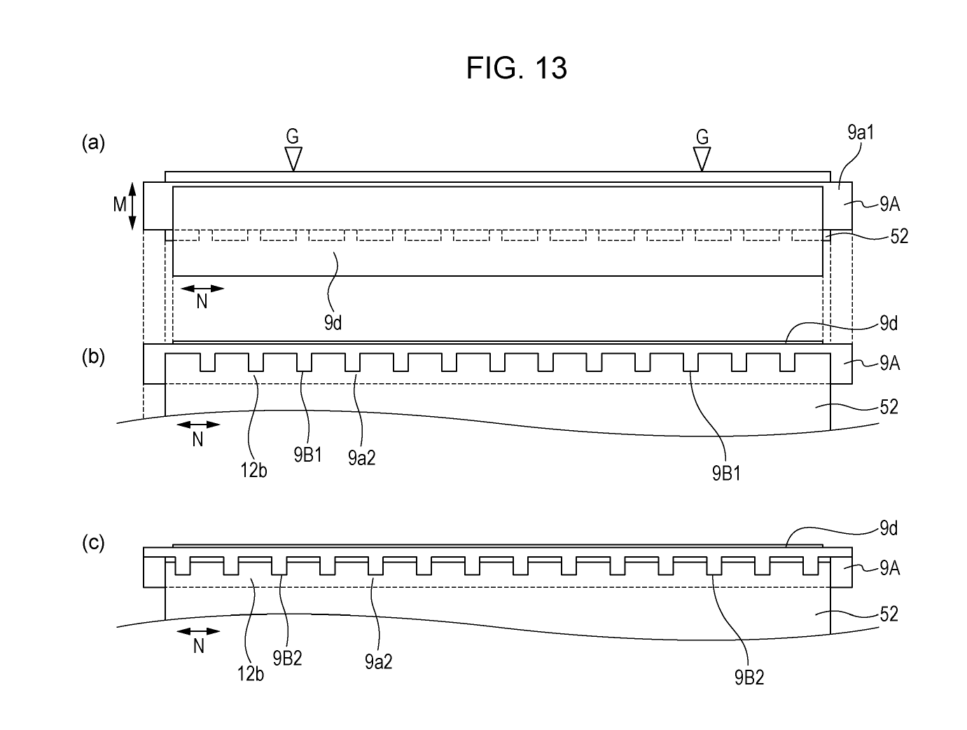

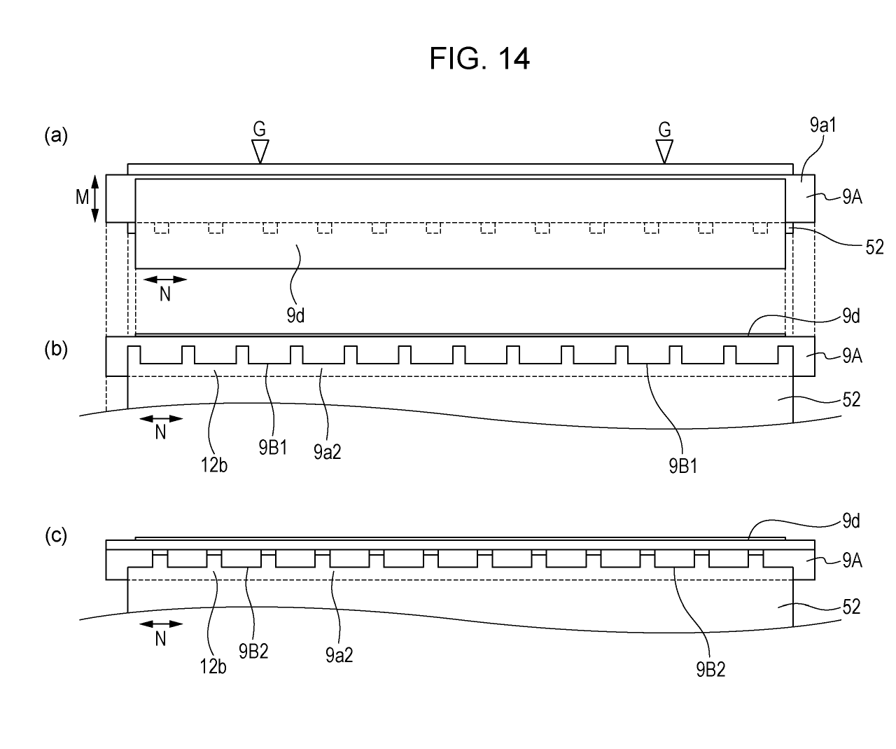

According to the sixth embodiment, the exposure portions 9B1 and the exposure portions 9B2 are respectively provided in the outer side surface and the inner side surface of the second securing portion 12b, which supports the first support member 9a, such that the row of the exposure portions 9B1 and the row of the exposure portions 9B2 are staggered with respect to each other in the longitudinal direction N. However, this is not limiting. For example, as long as the amount F of bending is tolerable, as illustrated in FIG. 13, the exposure portions 9B1 and 9B2 are not necessarily superposed on each other in the longitudinal direction N, and the first support member 9a may clamped between the outer side surface and the inner side surface of the second securing portion 12b at specified intervals. Alternatively, as illustrated in FIG. 14, the exposure portions 9B1 and the exposure portions 9B2 for the first support member 9a may be superposed on one another in the longitudinal direction N so as to further reduce the stress.

According to the sixth embodiment, the ratio of exposure of the first support member 9a from the developing container 52 to a width H of an opening for developing in the longitudinal direction N is about 50%. However, as long as the amount of bending is tolerable, the ratio of exposure from the developing container 52 may be 50% or less. In contrast, when there is no concern over reduction in stiffness of the developing container 52 or dropping of the first support member 9a, the ratio of exposure of the first support member 9a from the developing container 52 may be 50% or more.

Although the developing blade 9d is directly secured to the first support member 9a according to the above-described embodiments, this is not limiting. For example, the first support member 9a may be disposed as a reinforcing member in the resin that forms the developing container 52, and the developing blade 9d may be secured to the developing container 52.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-124748, filed Jun. 17, 2014, and No. 2015-095772, filed May 8, 2015, which are hereby incorporated by reference herein in their entirety.

### REFERENCE SIGNS LIST

7 photosensitive drum
8 charging roller
9a first support member
9c developing roller
9d developing blade
10a cleaning blade
9a3 notch portion
9A exposed portion
10c second support member
11 toner container
12, 42, 52 developing container
13 cleaning container
13a waste toner chamber
13b anti-leakage sheet
A main body of image forming apparatus
B cartridge
C cleaning unit
D developing unit
G gate portion
T developer unit
L laser light

1. A cartridge comprising:
a rotatable rotating member;
a blade that extends in an axial direction of the rotating member and that is in contact with or disposed close to a surface of the rotating member; a support member that supports the blade such that one end side of the blade projects toward the rotating member in a lateral direction that intersects the axial direction; and
a frame body that is formed by insert molding in which resin is injected while the support member is secured to a mold and that clamps part of the support member so as to support the support member,
wherein the frame body allows a movement of the support member in the axial direction.

2. The cartridge according to claim 1, wherein the frame body does not regulate the support member in the axial direction.

3. The cartridge according to claim 2,
wherein the support member has at least one notch portion so that the support member is positioned in the axial direction, and
wherein the resin that forms the frame body is engaged with the at least one notch portion so as to position the support member relative to the frame body in the axial direction.

4. The cartridge according to claim 3, wherein the at least one notch portion includes a plurality of notch portions arranged at intervals in the axial direction, and a length of each of the intervals is less than half a length of the support member in the axial direction.

5. The cartridge according to claim 1, wherein the frame body supports the support member such that one end portion of the support member in the axial direction is exposed from the frame body.

6. The cartridge according to claim 5,
wherein the support member has at least one notch portion,
wherein, in the support member disposed in the frame body, an interval between another end portion of the support member and the at least one notch portion in the axial direction of the support member is less than half a length of the support member in the axial direction, and
wherein the resin that forms the frame body is formed so as to be engaged with the at least one notch portion, so that the at least one notch portion is positioned relative to the frame body in the axial direction.

7. The cartridge according to claim 5,
wherein the support member has a plurality of notch portions arranged at intervals in the axial direction, and
wherein a length of each of the intervals is less than half a length of the support member in the axial direction.

8. The cartridge according to claim 1,
wherein the support member is longer than the frame body in the axial direction.

9. The cartridge according to claim 1,
wherein the support member is formed of a bent metal sheet that extends in the axial direction.

10. The cartridge according to claim 1,
wherein the frame body has a plurality of first contact portions and at least one first exposure portion in one surface of the frame body that extends in the axial direction,
wherein the support member is exposed through the at least one first exposure portion, and
wherein the frame body and the support member are in contact with each other at the plurality of first contact portions with the at least one first exposure portion interposed therebetween.

11. The cartridge according to claim 10, wherein the at least one first exposure portion includes a plurality of first exposure portions.

12. The cartridge according to claim 10,
wherein the frame body has a gate portion or gate portions through which the resin is injected, and
wherein the at least one first exposure portion or the plurality of first exposure portions are provided in a section or sections that intersect the axial direction at a part or parts where the gate portion or the gate portions are provided.

13. The cartridge according to claim 10,
wherein the frame body has a plurality of second contact portions and at least one second exposure portion in another surface of the frame body that extends in the axial direction,
wherein the support member is exposed through the at least one second exposure portion, and
wherein the frame body and the support member are in contact with each other at the plurality of second contact portions with the at least one second exposure portion interposed therebetween.

14. The cartridge according to claim 13, wherein the at least one second exposure portion includes a plurality of second exposure portions.

15. The cartridge according to claim 13, wherein the at least one first exposure portion or the plurality of first exposure portions are provided together with the at least one second exposure portion or the plurality of second exposure portions in a section or sections that intersect the axial direction.

16. The cartridge according to claim 1, wherein a bearing member that supports the rotating member is secured to the frame body.

17. The cartridge according to claim 1, wherein the frame body has a bearing portion that supports the rotating member.

18. The cartridge according to claim 1, wherein the rotating member is a photosensitive drum, and wherein the blade is a cleaning blade that removes developer from a surface of the photosensitive drum.

19. The cartridge according to claim 1,
wherein the rotating member is a developer bearing member, and
wherein the blade is a developing blade that regulates a thickness of the developer borne by the developer bearing member.

20. An image forming apparatus, wherein the cartridge according to claim 1 is attachable to and detachable from the image forming apparatus.

21. A frame body for a cartridge that is attachable to and detachable from an image forming apparatus,
wherein the frame body is formed by insert molding in which resin is injected while a reinforcing member is secured to a mold,
wherein part of at least one surface of the reinforcing member is exposed, and
wherein the frame body allows a movement of the support member in the axial direction.

22. The frame body according to claim 21, wherein part of the reinforcing member is clamped by the frame body so that the reinforcing member is supported.
